(19) United States
(12) Patent Application Publication
(10) Pub. No.: US 2016/0038958 A1
(43) Pub. Date: Feb. 11, 2016

(54) PRESSURE ASSISTED LIQUID SUPPLY ASSEMBLY

(71) Applicant: 3M INNOVATIVE PROPERTIES COMPANY, Saint Paul, MN (US)

(72) Inventors: Stephen C. P. Joseph, Woodbury, MN (US); Scott D. Gullicks, Woodbury, MN (US)

(73) Assignee: 3M INNOVATIVE PROPERTIES COMPANY, St. Paul, MN (US)

(21) Appl. No.: 14/775,943

(22) PCT Filed: Mar. 12, 2014
(86) PCT No.: PCT/US14/24093

§ 371 Date: Sep. 14, 2015

Related U.S. Application Data
(60) Provisional application No. 61/790,985, filed on Mar. 15, 2013.

(51) Int. Cl. B05B 11/04; B05B 7/24

(52) U.S. Cl. CPC B05B 11/048; B05B 7/2478; B05B 7/2481

(57) ABSTRACT

Provided are coating liquid reservoirs for use with a fluid inlet of a spray gun, the coating liquid reservoir comprising: a flexible outer pouch and a flexible inner pouch nested within the outer pouch, the inner pouch defining a coating liquid chamber, wherein upon supply of an external pressure source into a pressure zone between the inner and outer pouches, pressure is applied to the coating liquid chamber thereby expelling a liquid from the coating liquid chamber. The outer pouch inflates upon application of pressure in the pressure zone. Methods of making and using the same are also provided.

### TECHNICAL FIELD

This disclosure relates to liquid supply assemblies that supply liquids to be sprayed (e.g., paint) to spraying devices such as spray guns, and in one aspect, liquids are supplied to liquid spraying devices or spray guns from within collapsible liners that are located within a flexible and/or inflatable pouch.

### BACKGROUND

Spray guns are known for use in the application of liquids such as paints across many industries. Such spray guns commonly include a gun body, a reservoir for holding a liquid to be sprayed, and an air source to assist in atomizing and propelling the liquid onto a surface to be coated. Often, coating liquids are expensive, and it is therefore desirable to use as much of the liquid as possible to minimize waste. Moreover, relatively viscous coating liquids can be difficult to remove from the reservoir under the influence of gravity or a siphon.

There is an on-going need for improved systems and methods for dispensing and/or removing coating liquids from a reservoir for application by a spray gun.

### SUMMARY

Provided are coating liquid reservoirs, liquid supply assemblies, and methods of using the same. In a first aspect, a coating liquid reservoir is provided for use with a fluid inlet of a spray gun, the coating liquid reservoir comprising: a flexible outer pouch and a flexible inner pouch nested within the outer pouch, the inner pouch defining a coating liquid chamber. The outer and inner pouches comprise a first film and a second film, respectively. The outer pouch comprises an inlet port through its film. The inner pouch also comprises a fluid aperture. The fluid aperture is in fluid communication with the coating liquid chamber and, upon assembly with the fluid inlet of the spray gun. A pressure zone is located between the outer surface of the inner pouch and the inner surface of the outer pouch. Upon supply of an external pressure source to the inlet port, pressure is applied in the pressure zone thereby expelling a liquid from the coating liquid chamber through the fluid aperture. Due to its flexible nature, the outer pouch may inflate upon application of pressure in the pressure zone. The films of the inner pouch and the outer pouch may comprise, for example, polyethylene. A lid member may also be provided to the coating liquid reservoir. The inner pouch may comprise a coupler defining the fluid aperture.

In one embodiment, the lid member affixes the coating liquid reservoir to the body of the spray gun upon assembly. The liquid coating reservoir may further comprise a retention member that may be located as desired, for example, on the lid member, or on the coupler, or on the outer pouch. An embodiment provides that the outer pouch comprises a resealable opening. Another embodiment provides that the outer pouch further comprises a connecting member that is matable with the lid member.

In one or more embodiments, the coating liquid chamber has a capacity of at least 180 milliliters (6 ounces). The inner pouch may be pre-packaged with the liquid, that is intended to be sprayed or applied using, for example, the spray gun or a liquid supply assembly described herein.

One embodiment provides that the inner pouch, the outer pouch, or both comprise bellows, one or more gussets, and/or a plurality of ribs.

Another embodiment provides that the film of the inner pouch is foiled and the film of the outer pouch is transparent

In another aspect, a liquid supply assembly comprises a coating liquid reservoir disclosed herein and an air supply assembly. In an embodiment, the air supply assembly comprises a pressure regulator in fluid communication with a source of air under pressure. In another embodiment, the air supply assembly further comprises a first air line coupled to the inlet port of the outer pouch and a second air line coupled to the first air line, wherein the second air line is in fluid communication with the pressure regulator and the source of air under pressure.

In one or more embodiments, the air supply assembly supplies an air pressure of up to about 40 pounds per square inch (psi) (276 kilopascals) in a pressure zone between the outer surface of the inner pouch and the inner surface of the outer pouch. A detailed embodiment provides that the air supply assembly supplies an air pressure in the range of about 0.1 to about 10 psi, or even about 10 to about 25 psi, or even about 25 to 40 psi in the pressure zone.

One or more embodiments provide that upon assembly with a spray gun, the air supply assembly is connected to an air outlet on the spray gun itself communicating with a source of air under pressure used to shape a spray stream of liquid from an outlet nozzle on the spray gun.

Other aspects include methods for supplying a liquid to a spray gun, the methods comprising: providing a coating liquid reservoir disclosed herein; and assembling the coating liquid reservoir with the spray gun. The methods may further comprise assembling an air supply assembly with the coating liquid reservoir.

These and other aspects of the invention are described in the detailed description below. In no event should the above summary be construed as a limitation on the claimed subject matter.

### BRIEF DESCRIPTION OF THE DRAWINGS

The accompanying drawings are included to provide a further understanding of the invention described herein and are incorporated in and constitute a part of this specification. The drawings illustrate exemplary embodiments. Certain features may be better understood by reference to the following detailed description when considered in connection with the accompanying drawings, in which like reference numerals designate like parts throughout the figures thereof, and wherein:

FIG. 1 is a perspective view of a liquid supply assembly according to an embodiment;

FIG. 2 is an illustration of an exemplary coating liquid reservoir;

FIG. 3 is an illustration of a lid member and retention member of the coating liquid reservoir of FIG. 2;

FIG. 4 is an exploded perspective view of an exemplary coating liquid reservoir;

FIG. 5 is a perspective view of another exemplary coating liquid reservoir;

FIG. 6 is an exploded perspective view of another exemplary coating liquid reservoir; and

FIG. 7 is an exemplary outer pouch.

The figures are not necessarily to scale. Like numbers used in the figures refer to like components. It will be understood, however, that the use of a number to refer to a component in a given figure is not intended to limit the component in another figure labeled with the same number.

### DETAILED DESCRIPTION

Use of a flexible outer pouch permits visual feedback that the system is pressurizing (walls expand). The flexible outer pouch may inflate to provide support to the overall system (vs. a heavier rigid cup). In addition, use of a film-based outer pouch results in a reduced packaging volume if an inner pouch is supplied pre-assembled within the outer pouch vs. a rigid cup or container.

Before describing several exemplary embodiments of the invention, it is to be understood that the invention is not limited to the details of construction or process steps set forth in the following description. The invention is capable of other embodiments and of being practiced or being carried out in various ways.

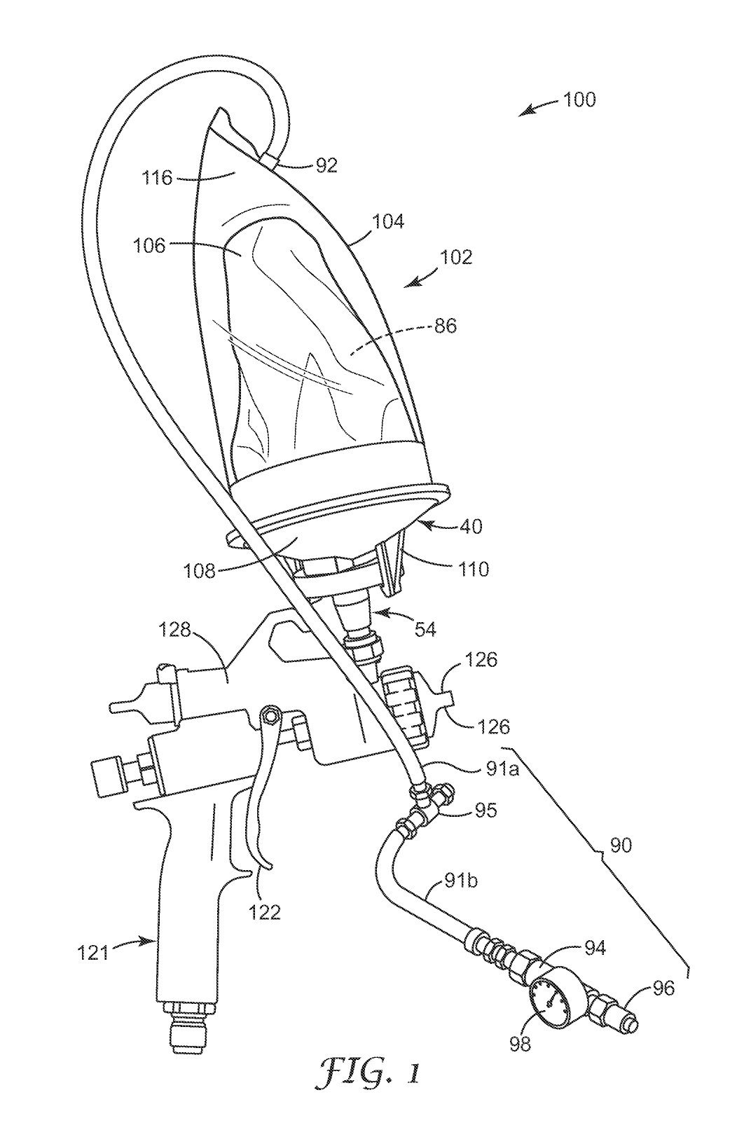

Turning to FIG. 1, a liquid supply assembly 100 according to an embodiment supplies a liquid to a spray gun 121 using pressure assist. The liquid supply assembly 100 comprises a coating liquid reservoir 102 having an outer pouch 104, an inner pouch 106, a pressure zone 116, an inlet port 92, a lid member 108, a retention member 110, and a fluid aperture defined by a coupler (not shown). In one or more embodiments, an air (or other suitable fluid source) supply assembly 90 supplies air (or fluid) at a desired or predetermined pressure in the pressure zone 116 located between the outer surface of the inner pouch 106, which can also be referred to as a liner, and the inner surface of the outer pouch 104, which can also be referred to as a container. The interior of the inner pouch 106 defines a coating liquid chamber 86.

The air supply assembly 90 includes a first length of air line 91a—typically flexible—having one end coupled to an inlet port 92 of the outer pouch 104. The inlet port 92 may incorporated into the outer pouch by methods known in the art. In one embodiment, the opposite end of the first air line 91a is coupled through an adjustable pressure relief valve 95 to an end of a second length 91b of flexible air line that has its opposite end coupled to the outlet port of a conventional pressure regulator 94 by which a source of higher pressure air coupled to an inlet port 96 of the regulator 94 can be reduced to a desired pressure indicated by a pressure gauge 98 on the regulator 94. The source of higher pressure air could be from a separate air line, or can preferably be from the same source of air pressure provided for the spray gun 11 through the bottom end of a handle for the spray gun 121, with the pressure regulator 94 attached at and supported from that bottom end of the handle for the spray gun 121. Other sources and/or configurations of air or other fluids are contemplated, such as those supplied internally by the spray gun 12 to the pressure zone 116.

In operation, the coating liquid chamber 86 is filled with a coating liquid, and the coating liquid reservoir 102 is connected to a structure such as an adapter 54 of a spray gun 121. In some instances, coating liquid chamber 86 may be supplied pre-filled with a coating liquid. As shown, the coating liquid reservoir 102 connects to the body 128 by the retention member 110 via an adapter 54.

A pressure relief member (not shown) may be advantageously employed in the coating liquid reservoir in order to release air pressure from the coating liquid reservoir 102 if the pressure zone 116 exceeds a predetermined pressure. In order to ensure proper functioning of the inner pouch to expel fluid or liquid, this predetermined pressure should be selected to be higher than expected operating pressures of the air pressure source. Such a pressure relief member is optional.

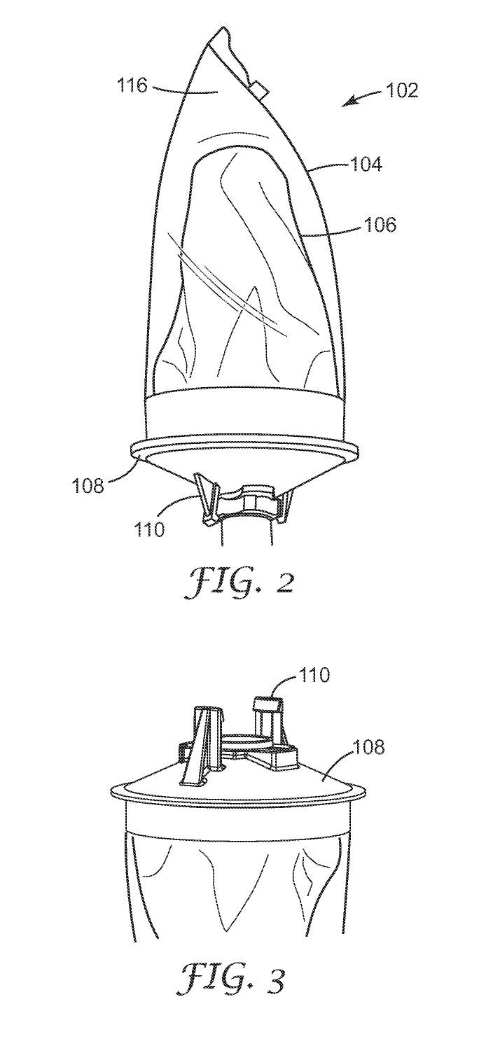

FIGS. 2 and 3 provide illustrations of the coating liquid reservoir 102, where the inner pouch 104 contains a fluid or liquid for spraying from a spray gun and the outer pouch 104 is inflated to provide pressure to expel the fluid from the inner pouch 106. A lid member 108 is affixed to one end to seal up the pouches. A retention member 110 is used to retain the coating liquid reservoir 102 onto a component of a spray gun, such as an adapter. In FIG. 3, the coupler is not shown, but it is formed as needed for an application. The coupler may be a male or female connection, located on the inner pouch or a fluid inlet of the spray gun, depending on the application.

The outer pouch 104 is flexible, meaning that it is non-rigid. The outer pouch 104 may comprise any material or construction suitable for containing a pressurized fluid and for surrounding the inner pouch 106, which defines a coating liquid chamber 86. For example, the outer pouch 104 comprises flexible walls that may inflate upon supply of an external pressure source to pressure zone 116, which is the space between the outer pouch 104 and the inner pouch 106, the outer pouch 104 inflates and pressure is applied to the fluid in the coating liquid chamber 86, thereby expelling the fluid (upon actuation of the spray gun trigger 122). Such inflation may occur to the extent necessary to provide pressure against the coating liquid chamber 86, and need only last until application of the coating liquid is complete, after which the flexible walls of the outer pouch 104 may be collapsed or the outer pouch may be vented in some manner to relieve the excess pressure and/or be returned to its non-inflated state. The use of an inner pouch 106 nested within or otherwise incorporated into an outer pouch 104 may advantageously consume less space for storage and shipping purposes (due to being collapsible), and may additionally require less material and therefore be lighter and less costly. The inner and outer pouches 106, 104 may be fabricated from the same or different materials. Suitable materials include, but are not limited to: polyethylene, polypropylene (cast & orientated), PET (polyethylene terephtalate), PA (polyamide), PVC (polyvinylchloride), EVOH (ethylene vinyl alcohol) and/or co-extruded/multilayer film constructions thereof. The inner and outer pouches 106, 104 may independently be transparent, translucent, opaque, or foiled, and natural or colored, printed with indicia of source/contents/volume or any combination thereof. The inner and outer pouches 106, 104 may be fabricated from the same or different materials. The pouches may be made in various sizes, as desired, for example 180 milliliters (6 ounces), 600 milliliters (20.3 ounces) or 950 milliliters (32.1 ounces), or indeed any other size that is appropriate for a desired application. The inner and outer pouches 106, 104 may contain structural features to facilitate handling of the pouches and/or overall assembly. Such features include, but are not limited to, such as bellows and/or one or more gussets and/or ribs or other surface features.

The inner and outer pouches 106, 104 comprise one or more films that may be polymeric and may preferably be impermeable to the coating liquid, to the external pressure source/fluid, or to both. The coating liquid in the coating liquid chamber is fluidly isolated from the pressure zone 116. In any event, the pouches 106, 104 may comprise a single layer or multiple layers of material suitable for achieving the functions described herein. As desired, the inner and outer pouches 106, 104 may be independently disposable. In certain embodiments, the inner pouch 106 is removable from the outer pouch 104, and may be replaced by a new pouch.

The inner pouch 106 may comprise a material that permits the coating liquid chamber to collapse as pressure is applied to an outer surface thereof and coating liquid is expelled. In one or more embodiments, the inner pouch 106 comprises a thermo/vacuum formed liner member as described, for example, in U.S. Pat. No. 7,798,426 to Joseph et al., the disclosure of which is incorporated by reference herein in its entirety (see, e.g., reference number 13 therein, along with associated description and figures).

An exemplary configuration of the inner and outer pouches independently include a pouch that is thermo/vacuum-formed from a sheet of low density polyethylene to have a side wall about 0.004 to 0.01 inch or 0.1 to 0.25 mm thick and a bottom wall about 0.001 inch or 0.25 mm thick or thicker so that the bottom wall tends to stay generally planer as the side wall collapses. Such pouches may also be formed from an extruded (mono or multi layer) film that would be folded and sealed (heat or otherwise) at the edges. Outer pouches as used herein would be provided with an aperture for accommodating the liquid aperture of the inner pouch and an inlet for receiving a fluid supply. In one embodiment, the outer pouch may be thermoformed and the inner pouch may be created from a flat film, which was sealed at the edges. In another embodiment, the inner pouch may be thermoformed and the outer pouch may be created from a flat film, which was sealed at the edges. Fabrication of the inner and outer pouches may depending on the application and/or required specification for the coating liquid reservoir.

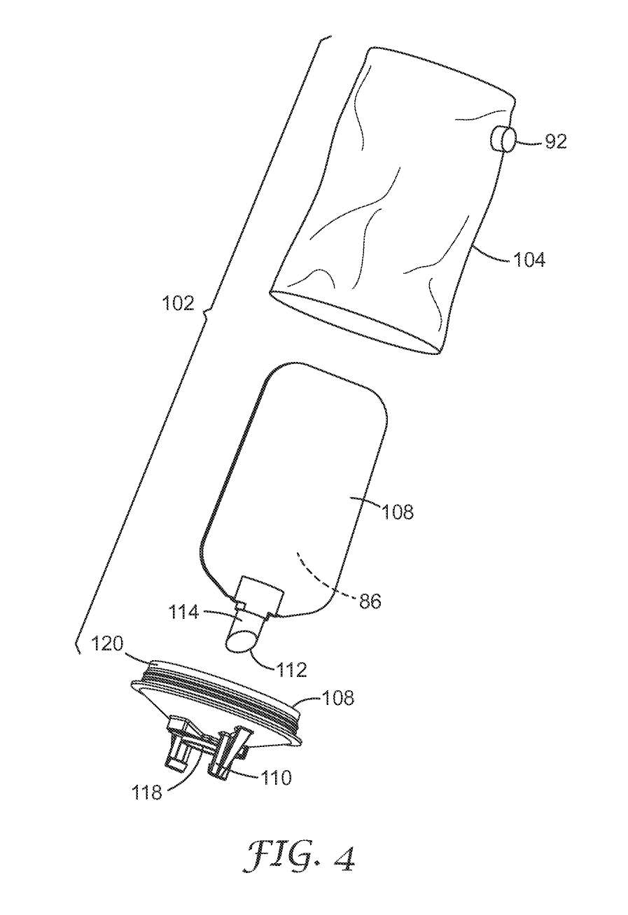

FIG. 4 is an exploded perspective view of an exemplary coating liquid reservoir. When the coating liquid reservoir 102 is connected to a spray gun, there is a fluid connection between the fluid aperture 112 and a chamber of the body of the spray gun. When air pressure is supplied to the pressure zone through inlet port 92, the coating liquid in the coating liquid chamber 86 receives pressure and is “squeezed” out through the fluid aperture 112, once the trigger 122 is actuated. Location of the inlet port on the outer pouch may be chosen based on application and availability of pressure sources. For example, the inlet port 92 may be located on any portion of the outer pouch 104, or on the lid member 108, or any other portion of the coating liquid reservoir 102 located to permit fluid communication to an air source provided externally of the coupler 114. There may be more than one inlet port as applicable.

In some embodiments, the lid member 108 is rigid. In other embodiments, the lid member 108 is at least partly flexible (i.e., rigid at the retention member 110 to provide a secure connection to the spray gun, but flexible elsewhere). Yet further embodiments may provide lid members that are mostly or all flexible. The lid member 108 may include a neck feature 120—or other sealing attachment feature—that sealably attaches to the inner and/or outer pouches. As assembled, the coupler 114 of the inner pouch extends through an opening 118 in the lid member 108. The coupler 114 may comprise male and/or female portions, threads, bayonets, snap-fits, or any other standard or quick-connect coupling features. The coupler 114 may also include sealing features (not shown) to ensure a fluid tight connection is achieved.

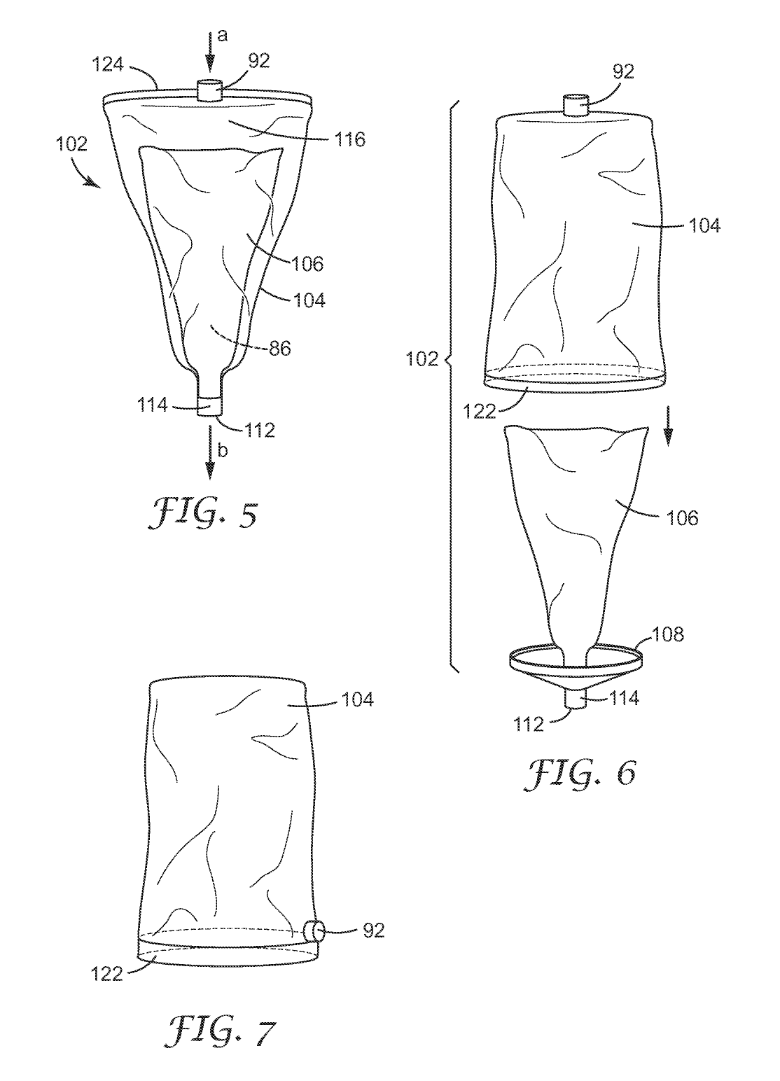

FIG. 5 is a perspective view of another exemplary coating liquid reservoir having only a fluid aperture 112 (also referred to as a fitment) and a coupler 114, but no lid. Upon introduction of air in the direction “a” through the inlet port 92 of the outer pouch 104 and into the pressure zone 116, the inner pouch 106 receives pressure and liquid from the coating liquid chamber 86 is expelled. The aperture (fitment) would connect into the body, or specifically, a fluid inlet, of a spray gun. In this particular embodiment, the inlet port to pressurize the system may be located at the top of the system. As needed in this lid-less embodiment, a retention member may be located on the outer pouch or the coupler or any other suitable location.

In one or more embodiments, the pouches may be pre-assembled and then the inner pouch filled, for example. Or the outer pouch could have a resealable opening 124, such as a zipper-type closure or a pressure sensitive adhesive such that a filled inner pouch could be inserted through the resealable opening. The outer pouch could then be closed. The resealable structure would be capable of withstanding operating pressures of the system, that is, those pressures adequate to inflate the outer pouch and to expel liquid from the coating liquid chamber.

In FIG. 6, which is an exploded perspective view of another exemplary coating liquid reservoir, a reusable outer pouch is depicted, which is assembled with the inner pouch/lid in the direction of arrow “c.” In this embodiment, outer pouch 104 is provided with a connecting member 122, such as a threaded member, for example, that may be used to assemble the coating liquid reservoir 102. That is, the inner pouch 106 with its coupler 114 and aperture/fitment 112 could mate with a lid 108 or other suitable structure, which itself can mate with the connecting member 122 of the outer pouch 104. In this way, the outer pouch 104 can be removed once the liquid of the inner pouch 106 is expelled and reconnected to another inner pouch/lid combination until it is determined that the outer pouch is no longer suitable for use.

In FIG. 7, an exemplary outer pouch 104 has a connecting member 122 with an inlet port 92 that may be integral with the connecting member. In this way, only a single molded structure to accompany the flexible outer pouch is needed to assembly the outer pouch with the inner pouch/lid combination. Inlet port 92 would be in fluid communication with the pressure zone (not shown) between the outer pouch 104 and an inner pouch.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments.

Although the invention herein has been described with reference to particular embodiments, it is to be understood that these embodiments are merely illustrative of the principles and applications of the present invention. It will be apparent to those skilled in the art that various modifications and variations can be made to the method and apparatus of the present invention without departing from the spirit and scope of the invention. Thus, it is intended that the present invention include modifications and variations that are within the scope of the appended claims and their equivalents.

What is claimed is:

1. A coating liquid reservoir for use with a fluid inlet of a spray gun, the coating liquid reservoir comprising:
a flexible outer pouch comprising a first film and an inlet port therethrough; and
a flexible inner pouch nested within the outer pouch, the inner pouch comprising a second film and defining a coating liquid chamber and a fluid aperture;
a pressure zone located between the outer surface of the inner pouch and the inner surface of the outer pouch;
wherein the fluid aperture is in fluid communication with the coating liquid chamber and, upon assembly, with the fluid inlet of the spray gun;
wherein upon supply of an external pressure source to the inlet port, pressure is applied in the pressure zone thereby expelling a liquid from the coating liquid chamber through the fluid aperture.

2. The coating liquid reservoir of claim 1, further comprising a lid member that affixes the coating liquid reservoir to the body of the spray gun upon assembly.

3. The coating liquid reservoir of claim 1, further comprising a retention member that is located on the lid member, the coupler, or the outer pouch.

4. The coating liquid reservoir of claim 1, wherein the inner pouch comprises a coupler that defines the fluid aperture.

5. The coating liquid reservoir of claim 2, wherein the outer pouch comprises a resealable opening.

6. The coating liquid reservoir of claim 1, wherein the coating liquid chamber has a capacity of at least 180 milliliters (6 ounces).

7. The coating liquid reservoir of claim 1, wherein the inner pouch is pre-packaged with the liquid.

8. The coating liquid reservoir of claim 1, wherein the films of the inner pouch and the outer pouch comprise polyethylene.

9. The coating liquid reservoir of claim 1, wherein the inner pouch, the outer pouch, or both comprise bellows, one or more gussets, or a plurality of ribs.

10. The coating liquid reservoir of claim 1, wherein the film of the inner pouch is foiled and the film of the outer pouch is transparent.

11. The coating liquid reservoir of claim 2, wherein the outer pouch further comprises a connecting member that is matable with the lid member.

12. The coating liquid reservoir of claim 1, wherein the outer pouch inflates upon application of pressure in the pressure zone.

13. A liquid supply assembly comprising:
the coating liquid reservoir of claim 1; and
an air supply assembly.

14. The liquid supply assembly of claim 13, wherein the air supply assembly comprises a pressure regulator in fluid communication with a source of air under pressure.

15. The liquid supply assembly of claim 14, wherein the air supply assembly further comprises a first air line coupled to the inlet port of the outer pouch and a second air line coupled to the first air line, wherein the second air line is in fluid communication with the pressure regulator and the source of air under pressure.

16. The liquid supply assembly of claim 13, wherein the air supply assembly supplies an air pressure of about 40 pounds per square inch (psi) (276 kilopascals) or less in a pressure zone between the outer surface of the inner pouch and the inner surface of the outer pouch.

17. The liquid supply assembly of claim 16, wherein the air supply assembly supplies an air pressures in the range of about 0.1 to 10 pounds per square inch (0.7 to 69 kilopascals) in the pressure zone.

18. The liquid supply assembly of claim 13, wherein upon assembly with a spray gun, the air supply assembly is connected to an air outlet on the spray gun communicating with a source of air under pressure used to shape a spray stream of liquid from an outlet nozzle on the spray gun.

19. A method for supplying a liquid to a spray gun, the method comprising:
providing the coating liquid reservoir of claim 1; and
assembling the coating liquid reservoir with the spray gun.

20. The method of claim 19, further comprising assembling an air supply assembly with the coating liquid reservoir.
